(19) United States
(12) Patent Application Publication
(10) Pub. No.: US 2014/0003026 A1
(43) Pub. Date: Jan. 2, 2014

(54) BIODEGRADABLE CHEMILUMINESCENT ARTICLES

(71) Applicant: John Mark Friedson, Longmeadow, MA (US)

(72) Inventor: John Mark Friedson, Longmeadow, MA (US)

(73) Assignee: OMNIGLOW, LLC, West Springfield, MA (US)

(21) Appl. No.: 13/542,280

(22) Filed: Jul. 5, 2012

Related U.S. Application Data
(60) Provisional application No. 61/667,223, filed on Jul. 2, 2012.

(51) Int. Cl. F21K 2/06

(52) U.S. Cl. 362/34

(57) ABSTRACT

A biodegradable chemiluminescent article is provided. The article includes a chemiluminescent system including an oxalate component containing a solvent mixture of about 50 wt. % of propylene glycol dibenzoate and about 50 wt. % of methyl benzoate. A container is formed from a blend of at least one non-biodegradable polymer and an additive that makes the non-biodegradable polymer biodegradable.

### CROSS-REFERENCE TO RELATED APPLICATION DATA

This application claims the benefit of priority of U.S. Provisional patent application Ser. No. 61/667,223, filed Jul. 2, 2012, the disclosure of which is incorporated herein in its entirety.

### BACKGROUND

The present disclosure relates to chemiluminescent systems, and more particularly to biodegradable chemiluminescent articles.

Chemiluminescent formulations include chemical substances that convert a chemical energy into cool light through an exothermic reaction. In such a reaction, the energy released from the exothermic reaction is manifested not as heat, but as light. The released energy is absorbed by electrons in certain molecules, and causes the electrons to jump to a higher level (an excited state). As the electrons in the excited state return to the lower ground state, they release energy that can be seen as a photon of light. This process is referred to as chemiluminescence.

Chemiluminescent systems typically include two chemical components, i.e. an oxalate component and an activator/peroxide component, which are kept separated until a desired time. The oxalate component generally includes an oxalate ester and a solvent, and the activator component generally includes hydrogen peroxide and a solvent. Further, a fluorescer compound and a catalyst for enhancing luminescence intensity and lifetime control are typically included in one or both component solutions. Commercially available glow products typically utilize a chemiluminescent reaction between hydrogen peroxide and an oxalate ester. This oxidation reaction produces two molecules of carbon dioxide, and releases energy that transfers to fluorescent dye molecules.

Chemiluminescence has been used in various glow-in-the dark novelty articles such as glow sticks, children's toys, safety devices, and the like. Further, chemiluminescence articles are widely used in the military and commercial fishing markets. It has been reported that over fifty million chemiluminescence devices are used and disposed annually between the military and commercial fishing markets. Since chemiluminescence articles are typically made using non-biodegradable materials, the waste created from disposing the chemiluminescent articles can be a serious environment concern.

Cranor, U.S. Pat. No. 7,052,631 discloses biodegradable chemiluminescent articles including a container and a chemiluminescent system. The container is formed from a “true” biodegradable plastic, i.e. biodegradable polymers that are either hydrolysable or water soluble, and inherently susceptible to environment degradation, such as polyesters, polyhydroxybutyrates, and vinyl polymers. The chemiluminescence system comprises an oxalate component including a 50/50 solvent mixture of propylene glycol dibenzoate and acetyltributyi citrate, and a peroxide component including about 85% tryethyl citrate, 10% t-butanol, 5% of 70% concentration hydrogen peroxide, and 0.0085% sodium salicylate.

However, another Cranor disclosure, US Patent No. 2009/0289237, teaches that the biodegradable plastics can negatively affect the oxalate/activator chemical light system after prolonged contact. Impurities or additives in such biodegradable plastics can leach into the liquid chemical system with time and react with the active ingredients in the chemiluminescent system. Further, some biodegradable plastics are negatively affected by the chemiluminescent light system. For example, the peroxide in the activator can crosslink some biodegradable plastics and change their properties, which can result in embrittlement and reduction in the shelf-life of the device.

Accordingly, there is a need for an improved biodegradable chemiluminescent system, which includes a biodegradable container and a biodegradable chemiluminescent system that do not negatively affect each other. These and other advantages of the invention, as well as additional inventive features, will be apparent from the description provided herein.

### BRIEF SUMMARY

In one aspect, a biodegradable chemiluminescent article includes a chemiluminescent system including an oxalate component formulated using an oxalate compound and a first solvent system containing about 50 wt. % of propylene glycol dibenzoate and about 50 wt. % of methyl benzoate. The chemiluminescent system also includes an activator component comprising hydrogen peroxide and a second solvent system. Further, at least one of the oxalate component and the activator component includes a fluorescer compound and a catalyst. The chemiluminescent article also includes a container formed from a biodegradable material. The oxalate component and the activator component are contained in the container separated from each other.

In another aspect, a biodegradable chemiluminescent article includes a chemiluminescent system that is formulated without using t-butanol. The chemiluminescent system includes an oxalate component and an activator component. The oxalate component includes an oxalate compound, and a first solvent system containing about 50 wt. % of propylene glycol dibenzoate and about 50 wt. % of methyl benzoate. The activator component includes hydrogen peroxide and a second solvent system. At least one of the oxalate component and the activator component includes a fluorescer compound and a catalyst. Further, the biodegradable chemiluminescent article includes a container formed from a biodegradable material. The oxalate component and the activator component are contained in the container separated from each other.

In yet another aspect, a biodegradable chemiluminescent article includes a container formed from a blend of at least one non-biodegradable polymer and an additive that makes the non-biodegradable polymer biodegradable. Further, the biodegradable chemiluminescent article includes a chemiluminescent system including an oxalate component and an activator component. The oxalate component includes an oxalate compound, and a first solvent system containing about 50 wt. % of propylene glycol dibenzoate and about 50 wt. % of methyl benzoate. The activator component includes hydrogen peroxide and a second solvent system. At least one of the oxalate component and the activator component includes a fluorescer compound and a catalyst. The oxalate component and the activator component are contained in the container separated from each other.

In one embodiment, the second solvent system of any one of the biodegradable chemiluminescent articles described above is selected from a group consisting of triethyl citrate, dipropylene glycol dimethyl ether, and a mixture thereof. Further, the container can be formed from a blend of at least one non-biodegradable polymer and an additive that makes the non-biodegradable polymer biodegradable. Alternatively, the container can be a multilayer container including a first layer formed of at least one non-biodegradable polymer, and a second layer formed of an additive that makes the non-biodegradable polymer biodegradable.

In another embodiment, the non-biodegradable polymer for the container is selected from the group consisting of polydivinyl benzene, ethylene vinyl acetate copolymers, polyethylene, polypropylene, polystyrene, polyterethalate, polyesters, polyvinyl chloride, polymethyl methacrylate, polycarbonate, polyamide, and any copolymers thereof. The additive comprises a chemo-attractant compound, a glutaric acid or its derivative, a carboxylic acid compound with chain length from 5-18 carbons, a polymer, and a swelling agent.

Other aspects, objectives and advantages will become more apparent from the following detailed description.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is an illustration of a glow-in-the dark light stick according to an embodiment; and

FIG. 2 is an illustration of a glow-in-the dark necklace according to an embodiment.

### DETAILED DESCRIPTION

While the present disclosure is susceptible of embodiment in various forms, there will hereinafter be described a presently preferred embodiment with the understanding that the present disclosure is to be considered an exemplification and is not intended to limit the disclosure to the specific embodiment illustrated. The words “a” or “an” are to be taken to include both the singular and the plural. Conversely, any reference to plural items shall, where appropriate, include the singular.

A biodegradable chemiluminescent article including a container and a chemiluminescent system is provided according to an embodiment. The container is formed of a biodegradable material. The chemiluminescent system generally includes an oxalate component and an activator component, which are kept separated in the container until a desired time. For example, the oxalate component and the activator component can be placed in adjacent compartments in the container separated by a wall, which can be broken when desired to start a chemiluminescent reaction. Alternatively, one of the components can be placed in a fragile vial, such as a glass vial, which is arranged in an interior chamber of a container containing the other component. In such an embodiment, the fragile vial can be broken to start a chemiluminescent reaction. The biodegradable material for the container and ingredients of the chemiluminescent system are selected such that the biodegradable material and the components of the chemiluminescent system do not react with one another over time.

In one embodiment, the oxalate component includes an oxalate and a solvent system. Preferably, the solvent system includes a biodegradable solvent or a mixture of biodegradable solvents. In one embodiment the solvent system a mixture of about 50 wt. % of propylene glycol dibenzoate and about 50 wt. % of methyl benzoate. Other suitable solvent mixtures include a mixture of about 50 wt. % of propylene glycol dibenzoate and about 50 wt. % of acetyltributyl citrate, and a mixture of about 50 wt. % acetyltributyl citrate and about 50 wt. % methyl benzoate. Other similar mixture formulations of biodegradable solvents can also work.

Suitable oxalates include, but are not limited to, bis (2-carbalkoxy-3,4,6-trichlorophenyl) oxalate, e.g., the 2-carbobutoxy and 2-carbopentoxy compounds, bis (3-carbalkoxy-2,4,6-trichlorophenyl) oxalate, bis(4-carbalkoxy-2,3,6-trichlorophenyl)oxalate, bis(3,5-dicarbalkoxy-2,4,6-trichlorophenyl oxalate. Bis(2,3-dicarbalkoxy-4,5,6 trichlorophenyl)oxalate, bis (2,4-dicarbalkoxy-3,5,6-trichlorophenyl) oxalate, bis (2,5-dicarbalkoxy-3,4,6-trichlorophenyl)oxalate, bis(2,6-dicarbalkoxy-3,4,5-trichlorophenyl) oxalate, bis(3-carbalkoxy-2,4,5,6-tetrachlorophenyl)oxalate, bis (2-carbalkoxy-3,4,5,6-tetrachlorophenyl)oxalate, bis(4-carbalkoxy-2,3,5,6-tetrachlorophenyl) oxalate, bis(6-carbalkoxy-2,3,4-trichlorophenyl) oxalate, bis(2,3,-dicarbalkoxy-4,6-dichlorophenyl)oxalate, bis(3,6-dicarbalkoxy-2,4-dichlorophenyl)oxalate, bis(2,3,5-tricarbalkoxy-4,6-dichlorophenyl)oxalate, bis(3,4,5-tricarbalkoxy-2,6-dichlorophenyl)oxalate, bis(2,4,6-tricarbalkoxy-3,5-dichlorophenyl)oxalate, bis(3-bromo-6-carbohexoxy-2,4,5-trichlorophenyl)oxalate, bis(bis(3-bromo-2-carbethoxy-4,6-dichlorophenyl)oxalate, bis(2-carbethoxy4,6-dichloro-3-nitrophenyl)oxalate, bis [2-carbomethoxy-4,6-dichloro-3-(trifluoromethyl)phenyl]oxalate, bis(2-carbobutoxy-46-dichloro-3-cyanophenyl)oxalate, bis(2-carboctyloxy-4,5,6-trichloro-3-ethoxyphenyl)oxalate, bis(2-carbobutoxy-3,4,6-trichloro-5-ethoxphenyl) oxalate, bis(2-carbisopropoxy-3,4,6-trichloro-5-methylphenyl)oxalate, bis(2-carbisopropoxy-4,6-dichloro-5 octylphenyl) oxalate, bis[2-carbomethoxy-3,5,6-trichloro-4-(1,1,3,3-tetramethylbutyl)phenyl] oxalate, bis{2-[carbobis(trifluoromethyl) methoxy]-3,4,5,6-tetrafluorophenyl} oxalate, bis(3,4,6-tribromo-2-carbocyclohexoxyphenyl)oxalate, bis(2,4,5-tribromo-6-c arbophenoxy-3-hexadecylphenyl)oxalate, bis(2,4,5-trichloro-6-carbobutoxyphenyl)oxalate and bis (2,4,5-trichloro-6-carbopentoxyphenyl)oxalate.

Further, the oxalate component can also include one or more fluorescent compounds. The fluorescent compound is selected such that it is sufficiently soluble in the solvent mixture. Suitable fluorescent compounds include, but are not limited to, polycyclic aromatic compounds having at least three fused rings, such as anthracene, substituted anthracene, benzanthracene, phenanthrene, substituted phenanthrene, napthacene, substituted naphthacene, pentacene, substituted pentacene, perylene, substituted perylene, and the like. Typical substituents for all of these are phenyl, lower alkyl(C₁-C₆), chloro, bromo, cyano, and alkoxy (C₁-C₁₆). For example, the oxalate component can include 9,10-bis(phenylethynyl)anthracene, or 1-chloro-9,10-bis (phenylethynyl)anthracene.

In some embodiments, the oxalate component also includes a catalyst for enhancing luminescence intensity and lifetime control. Examples of suitable catalysts include, but are not limited to, sodium salicylate, tetrabutylammonium salicylate, lithium salicylate, potassium salicylate, rubidium chloride, lithium chloride, lithium sulfate, and tetrabutylammonium perchlorate.

The activator component includes a peroxide component and a solvent system. Examples of suitable peroxides include t-butylhydroperoxide, peroxybenzoic acid and hydrogen peroxide. Any suitable compound that produces hydrogen peroxide can also be used. Preferably, the peroxide component is hydrogen peroxide. In one preferred embodiment, the activator component solvent system is selected from dipropylene glycol dimethyl ether, triethyl citrate (TEC), and a mixture thereof. Further, a fluorescer compound and/or a catalyst can also be included in the activator component. The fluorescent compound is selected such that it is sufficiently soluble in the selected solvent system. Examples of fluorescent compounds include those listed above for the oxalate component. The fluorescent compound can be included in the oxalate component, in the peroxide component, or in the both components according to various embodiments. Examples of the catalyst include those listed above for the oxalate component. The catalyst can be included in the oxalate component, in the peroxide component, or in both components according to various embodiments. Preferably, the activator component does not include t-butanol, which decreases the flash point of the system and increases flammability.

The container comprises at least one polymer and an additive that enhances biodegradability of otherwise non-biodegradable polymers. The additive material can be added to various polymeric materials and colorants, and mixed into such materials to make them biodegradable without having to chemically alter the polymeric molecules. Preferably, the additive comprises a mixture of a furanone compound, a glutaric acid, a hexadecanoic acid compound, a polycaprolactone polymer, organoleptic swelling agent (natural fiber, cultured colloid, cyclo-dextri, polylactic acid, etc.) and a carrier resin to assist with placing the additive material into the polymeric material to be rendered biodegradable in an even fashion to assure proper biodegradation. Such an additive is disclosed in Lake, US Pub. 2008/0103232, and available from Bio-Tec Environmental, LLC under its tradename EcoPure®. Test results have confirmed that the additive does not negatively affect the shelf life, performance of the chemiluminescent system, or the function and performance of the container.

Examples of suitable polymers include, but are not limited to, straight chain and branched chain addition polymers, copolymers, as well as condensation polymers, including aliphatic as well as aromatic based polymers. More specifically the additive is effective in rendering polyethylenes, polypropylenes, polyvinyl acetates, poly lactic acids, poly caprolactones, poly glycolic acids, poly lactic-co-glycolic acids, polyvinyl chlorides, polystyrenes, polyterethalates, polyesters, and polyamides biodegradable so that they may be simply added to a land fill and in the presence or absence of oxygen to initiate biodegradation.

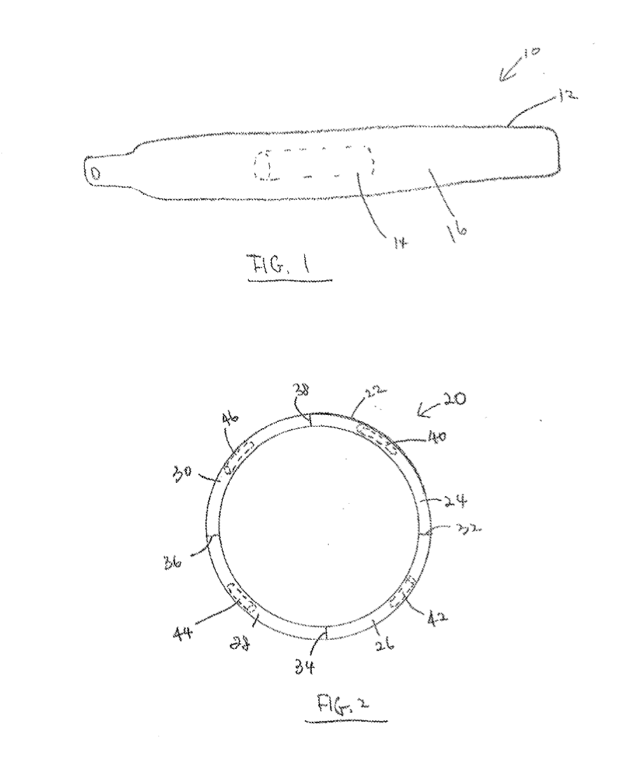

A blend of the at least one polymer and the additive can be used form various different containers for glow-in-the dark products. For example, a container 12 for a glow stick 10 (FIG. 1) can be formed of such a blend to provide biodegradability. The glow stick 10 also includes a glass vile 14 arranged in an internal chamber 16 of the container 12. Further the glow stick 10 includes a chemiluminescent system including an oxalate component and an activator component. The oxalate component comprises an oxalate compound, and a solvent mixture including about 50 wt. % of propylene glycol dibenzoate and about 50 wt. % of methyl benzoate. The activator component comprises hydrogen peroxide and a solvent selected from a group consisting of dipropylene glycol dimethyl ether, triethyl citrate, and a mixture thereof. The activator component is formulated without using t-butanol. Further, one or more fluorescent compound and a catalyst is include in the oxalate component, the activator component, or both.

One of the components is placed in the glass vile 14, while the other component is placed in the internal chamber 16. For example, the oxalate component can be placed in the glass vile 14 and the peroxide component can be place in the interior chamber 16, or vice versa. Thus, the oxalate component and the peroxide components are kept separate until a desired time. In use, a user can apply force by squeezing or bending the container 12 to break the glass vile 14, which causes the components to mix and start the chemiluminescent reaction. Alternatively, the container can be formed from a multilayer film or a multilayer tube including a layer of non-biodegradable polymer, such as polyethylene, which provides strength, protection, and a long shelf-life, and a layer of the additive, which provides biodegradability to the container.

FIG. 2 shows a glow-in-the dark necklace 20 according to another embodiment. The necklace 20 includes a container 22 including four chambers 24, 26, 28, 30. Each of the chambers 24, 26, 28, 30 is divided from its adjacent chamber by a wall 32, 34, 36, 38. An ampoule 40, 42, 44, 46 is arranged in each chamber 24, 26, 28, 30. Each of the ampoules 40, 42, 44, 46 contains an oxalate component of a chemiluminescent system. The ampoules 40, 42, 44, 46 containing the oxalate component are surrounded by an activator component contained in the corresponding chambers 24, 26, 28, 30. In this embodiment, at least some of the ampoules 40, 42, 44, 46 include different color oxalate components. For example, the ampoules 40 and 44 can include an oxalate component formulated with a yellow color fluorescer compound, while the ampoules 42 and 46 include an oxalate component formulated with a red color fluorescer compound. In another embodiment, each of the ampoules 40, 42, 44, 46 includes a different color oxalate component to provide a four-color necklace. At a desired time, a user can squeeze, twist, or use similar actions to break the ampoules 40, 42, 44, 46 to mix the components to start a chemiluminescent reaction. In other embodiments, a glow-in-the dark product can include two, three or more than four chambers. Further, various different shape and size containers can be formed for different glow-in-the dark products.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A biodegradable chemiluminescent article, comprising:
a chemiluminescent system including:
an oxalate component comprising an oxalate compound and a first solvent system, the first solvent system including about 50 wt. % of propylene glycol dibenzoate and about 50 wt. % of methyl benzoate;
an activator component comprising hydrogen peroxide and a second solvent system; and
wherein at least one of the oxalate component and the activator component includes a fluorescer compound and a catalyst; and
a container formed from a biodegradable material,
wherein the oxalate component and the activator component are contained in the container separated from each other.

2. The biodegradable chemiluminescent article of claim 1, wherein the second solvent system is triethyl citrate.

3. The biodegradable chemiluminescent article of claim 1, wherein the second solvent system is dipropylene glycol dimethyl ether.

4. The biodegradable chemiluminescent article of claim 1, wherein the second solvent system is a mixture of dipropylene glycol dimethyl ether and triethyl citrate.

5. The biodegradable chemiluminescent article of claim 1, wherein the first and/or second solvent systems are free of t-butanol.

6. The biodegradable chemiluminescent article of claim 1, wherein the biodegradable material comprises at least one non-biodegradable polymer, and an additive that makes the non-biodegradable polymer biodegradable.

7. The biodegradable chemiluminescent article of claim 6, wherein the non-biodegradable polymer is selected from the group consisting of polydivinyl benzene, ethylene vinyl acetate copolymers, polyethylene, polypropylene, polystyrene, polyterethalate, polyesters, polyvinyl chloride, polymethyl methacrylate, polycarbonate, polyamide, and any copolymers thereof.

8. The biodegradable chemiluminescent article of claim 6, wherein the additive comprises a chemo attractant compound, a glutaric acid or its derivative, a carboxylic acid compound with chain length from 5-18 carbons, a polymer, and a swelling agent.

9. The biodegradable chemiluminescent article of claim 1, wherein the container is formed from a blend of at least one non-biodegradable polymer and an additive that makes the non-biodegradable polymer biodegradable.

10. The biodegradable chemiluminescent article of claim 1, wherein the container is a multilayer container including a first layer formed of at least one non-biodegradable polymer, and a second layer formed of an additive that makes the non-biodegradable polymer biodegradable.

11. A biodegradable chemiluminescent article, comprising:
a chemiluminescent system including:
an oxalate component comprising an oxalate compound and a first solvent system, the first solvent system containing about 50 wt. % of propylene glycol dibenzoate and about 50 wt. % of methyl benzoate;
an activator component comprising hydrogen peroxide and a second solvent system; and
wherein at least one of the oxalate component and the activator component includes a fluorescer compound and a catalyst, and wherein each of the oxalate component and the activator component is free of t-butanol; and
a container formed from a biodegradable material,
wherein the oxalate component and the activator component are contained in the container separated from each other.

12. The biodegradable chemiluminescent article of claim 11, wherein the second solvent system is selected from a group consisting of triethyl citrate, dipropylene glycol dimethyl ether, and a mixture thereof.

13. The biodegradable chemiluminescent article of claim 11, wherein the container is formed from a blend of at least one non-biodegradable polymer and an additive that makes the non-biodegradable polymer biodegradable.

14. The biodegradable chemiluminescent article of claim 11, wherein the container is a multilayer container including a first layer formed of at least one non-biodegradable polymer, and a second layer formed of an additive that makes the non-biodegradable polymer biodegradable.

15. The biodegradable chemiluminescent article of claim 13, wherein the non-biodegradable polymer is selected from the group consisting of polydivinyl benzene, ethylene vinyl acetate copolymers, polyethylene, polypropylene, polystyrene, polyterethalate, polyesters, polyvinyl chloride, polymethyl methacrylate, polycarbonate, polyamide, and any copolymers thereof.

16. The biodegradable chemiluminescent article of claim 13, wherein the additive comprises a chemo attractant compound, a glutaric acid or its derivative, a carboxylic acid compound with chain length from 5-18 carbons, a polymer, and a swelling agent.

17. A biodegradable chemiluminescent article, comprising:
a chemiluminescent system including:
an oxalate component comprising an oxalate compound and a first solvent system;
an activator component comprising hydrogen peroxide and a second solvent system, wherein at least one of the oxalate component and the activator component includes a fluorescer compound and a catalyst; and
a container formed from a blend of at least one non-biodegradable polymer and an additive that makes the non-biodegradable polymer biodegradable, wherein the oxalate component and the activator component are contained in the container separated from each other.

18. A biodegradable chemiluminescent article of claim 17, wherein the first solvent system contains about 50 wt. % of propylene glycol dibenzoate and about 50 wt. % of methyl benzoate.

19. The biodegradable chemiluminescent article of claim 17, wherein the second solvent system is selected from a group consisting of triethyl citrate, dipropylene glycol dimethyl ether, and a mixture thereof, and the activator component is free of t-butanol.

20. The biodegradable chemiluminescent article of claim 17, wherein the non-biodegradable polymer is selected from the group consisting of polydivinyl benzene, ethylene vinyl acetate copolymers, polyethylene, polypropylene, polystyrene, polyterethalate, polyesters, polyvinyl chloride, polymethyl methacrylate, polycarbonate, polyamide, and any copolymers thereof.

21. The biodegradable chemiluminescent article of claim 17, wherein the additive comprises a chemo attractant compound, a glutaric acid or its derivative, a carboxylic acid compound with chain length from 5-18 carbons, a polymer, and a swelling agent.
